(19) United States
(12) Patent Application Publication
(10) Pub. No.: US 2022/0145861 A1
(43) Pub. Date: May 12, 2022

(54) VISUAL RECOGNITION SYSTEM FOR WIND TURBINES

(71) Applicant: Huaneng Tongliao Wind Power Co., Ltd., Tongliao (CN)

(72) Inventors: Guoqing Li, Tongliao (CN); Jinning Wang, Tongliao (CN); Guohui Zhang, Tongliao (CN); Yan Li, Tongliao (CN); Genmu Qing, Tongliao (CN); Pengfei Xie, Tongliao (CN); Yang Liu, Tongliao (CN); Jian Han, Tongliao (CN)

(21) Appl. No.: 17/402,638

(22) Filed: Aug. 16, 2021

(30) Foreign Application Priority Data
Nov. 9, 2020 (CN) 202011235808.X

(51) Int. Cl. F03D 17/00; F03D 80/50; G06T 7/00; H04N 7/18; G08B 21/18

(52) U.S. Cl. CPC F03D 17/00; F03D 80/50; G06T 7/0004; G06T 2207/30164; G08B 21/182; G06T 2207/10016; H04N 7/183

(57) ABSTRACT

A visual recognition system for wind turbines, including an intelligent analysis unit configured to analyze and determine data information, an intelligent service unit configured to transmit image data, a telecontrol platform, a graphic workstation, an intelligent processing unit configured to process video files, a router, a video storage unit configured to store video information, an intelligent binocular perception terminal, an intelligent perception terminal and an intelligent recognition terminal, where the intelligent binocular perception terminal, the intelligent perception terminal and the intelligent recognition terminal are connected to the video storage unit and the intelligent processing unit through optical fibers and the router. Real-time recognition of equipment defects and timely warning are achieved, operation and maintenance blind spots are reduced, the number of manual inspections is decreased, operation and maintenance efficiency is improved, operation and maintenance costs are reduced, and the safety risks of patrol personnel is reduced.

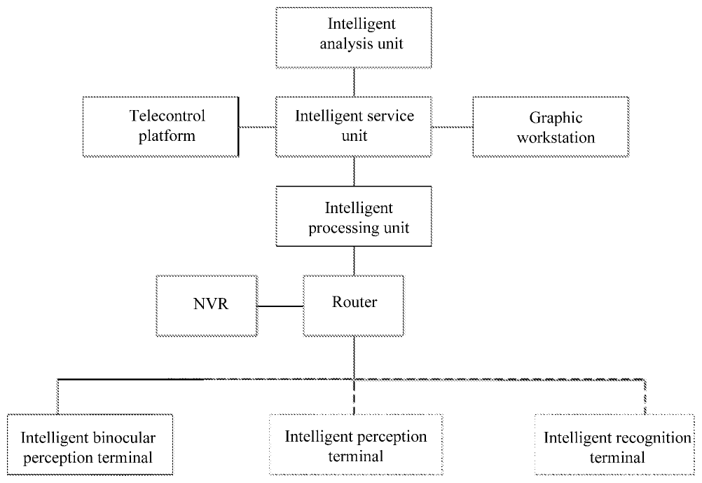

### CROSS REFERENCE TO RELATED APPLICATIONS

The present application claims the benefit of Chinese Patent Application No. 202011235808.X filed on Nov. 9, 2020, the contents of which are incorporated herein by reference in their entirety.

### TECHNICAL FIELD

The present disclosure relates to the technical field of wind turbine maintenance, and specifically, to a novel visual recognition system for wind turbines.

### BACKGROUND

As the most important part of the wind power generation system, wind turbines play a vital role in the operation of wind farms. With the rapid development of wind power generation, the proportion of wind power in the power grid continues to increase, and the number of wind turbines is also increasing. Because the wind farms have special requirements on environmental conditions, generally, the natural environment around the wind turbines is relatively harsh, with severe weather conditions such as high temperature, severe cold, high wind speed, sandstorm, salt fog, rain, snow, freezing, thunder and lightning. In addition, remote geographical locations, complex terrains, and inconvenient transportations affect the patrol inspection of the wind turbines. Currently, there are mainly the following two methods for operation and maintenance of the wind turbines: One is to install a common video monitoring system and various sensors in the wind turbines, and the operator views real-time video and monitors data changes in the sensors, to monitor the equipment operation status; the second is to arrange professionals to regularly conduct manual inspections on the wind turbines.

The existing operation and maintenance methods are relatively simple, not highly intelligent, and have a small monitoring range. Consequently, there are monitoring blind spots in which equipment conditions cannot be fully reflected. In addition, manual patrol inspections are difficult and time-consuming, and have high security risks. The current operation and maintenance methods cannot meet the increasing demand for wind power generation and need to be improved.

### SUMMARY

The purpose of the present disclosure is to provide a novel visual recognition system for wind turbines, to resolve the following problems mentioned above: The existing operation and maintenance methods are relatively simple, not highly intelligent, and have a small monitoring range. Consequently, there are monitoring blind spots in which equipment conditions cannot be fully reflected. In addition, manual patrol inspections are difficult and time-consuming, and have high security risks. The current operation and maintenance methods cannot meet the increasing demand for wind power generation.

In order to achieve the foregoing objectives, the present disclosure provides the following technical solutions: A novel visual recognition system for wind turbines includes an intelligent analysis unit configured to analyze and determine data information, an intelligent service unit configured to transmit image data, a telecontrol platform, a graphic workstation, an intelligent processing unit configured to process video files, a router, a video storage unit configured to store video information, an intelligent binocular perception terminal, an intelligent perception terminal and an intelligent recognition terminal, where the intelligent binocular perception terminal, the intelligent perception terminal and the intelligent recognition terminal are connected to the video storage unit and the intelligent processing unit through optical fibers and the router, the intelligent processing unit is connected to the intelligent service unit through a dedicated line, the intelligent service unit is connected to the telecontrol platform and the graphic workstation for data exchange and information display, and the intelligent service unit is connected to the intelligent analysis unit.

Preferably, the intelligent analysis unit analyzes and processes the image data transmitted by the intelligent service unit, recognizes equipment defects, equipment abnormalities, and abnormal monitoring data, and then generates and sends alarm information and alarm images to the intelligent service unit for subsequent processing.

Preferably, the intelligent service unit receives the image data processed by the intelligent processing unit, and transmits the image data to the intelligent analysis unit for analysis and determining, and the intelligent service unit sends, based on different requirements and levels, the received information such as the alarm information, alarm images and abnormal data to the telecontrol platform and the graphic workstation, to facilitate dispatchers and operation and maintenance personnel to make determinations and take effective measures to deal with abnormal situations.

Preferably, the intelligent processing unit receives the video files sent by the intelligent binocular perception terminal, the intelligent perception terminal and the intelligent recognition terminal, processes the video files to generate the image data, and sends the image data to the intelligent service unit.

Preferably, the intelligent binocular perception terminal, the intelligent perception terminal and the intelligent recognition terminal acquire video data and temperature monitoring data of a transmission chain system, a yaw system, a hydraulic system, a power generation system, a frequency converter, a main control system and surrounding areas.

Preferably, the intelligent binocular perception terminal is configured to recognize related equipment defects, smoke and open flames, and personnel violations, and monitor an equipment temperature in real time; and

the intelligent binocular perception terminal is specifically configured to: immediately issue an alarm when monitoring that the equipment temperature exceeds a threshold, such that the operation and maintenance personnel can take immediate measures to reduce the risk of accidents.

Preferably, the intelligent perception terminal presets a position at which the intelligent binocular perception terminal cannot acquire data, and then cyclically acquires videos of the preset position.

Preferably, the intelligent recognition terminal specifically acquires videos of key parts for recognizing special defects and trespasses.

The novel visual recognition system for wind turbines provided in the present disclosure has the following beneficial effects:

(1) According to the present disclosure, the intelligent binocular perception terminal, the intelligent perception terminal and the intelligent recognition terminal are provided, in addition to the intelligent analysis unit, the intelligent service unit and the intelligent processing unit, to comprehensively improve intelligent operation and maintenance of the wind turbines and prevent accidents, thereby providing a strong guarantee for the safe and stable operation of the wind turbines.

(2) The present disclosure provides a reasonable structure to take a clear night shoot and ceaselessly monitor the wind turbine related equipment and maintenance personnel. In this way, real-time recognition of equipment defects and timely warning are achieved, operation and maintenance blind spots are reduced, the number of manual inspections is decreased, operation and maintenance efficiency is improved, operation and maintenance costs are reduced, and the safety risks of patrol personnel is reduced. The present disclosure is convenient for promotion and use.

### BRIEF DESCRIPTION OF THE DRAWINGS

The sole FIGURE is a schematic structural diagram of a system according to the present disclosure.

### DETAILED DESCRIPTION

The following clearly and completely describes the technical solutions in the examples of the present disclosure with reference to the accompanying drawings in the examples of the present disclosure.

As shown in the sole FIGURE, the present disclosure provides a technical solution: A novel visual recognition system for wind turbines includes an intelligent analysis unit configured to analyze and determine data information, an intelligent service unit configured to transmit image data, a telecontrol platform, a graphic workstation, an intelligent processing unit configured to process video files, a router, a video storage unit configured to store video information, an intelligent binocular perception terminal, an intelligent perception terminal and an intelligent recognition terminal, where the intelligent binocular perception terminal, the intelligent perception terminal and the intelligent recognition terminal are connected to the video storage unit and the intelligent processing unit through optical fibers and the router, the intelligent processing unit is connected to the intelligent service unit through a dedicated line, the intelligent service unit is connected to the telecontrol platform and the graphic workstation for data exchange and information display, and the intelligent service unit is connected to the intelligent analysis unit.

The intelligent analysis unit analyzes and processes the image data transmitted by the intelligent service unit, recognizes equipment defects, equipment abnormalities, and abnormal monitoring data, and then generates and sends alarm information and alarm images to the intelligent service unit for subsequent processing.

The intelligent service unit receives the image data processed by the intelligent processing unit, and transmits the image data to the intelligent analysis unit for analysis and determining, and the intelligent service unit sends, based on different requirements and levels, the received information such as the alarm information, alarm images and abnormal data to the telecontrol platform and the graphic workstation, to facilitate dispatchers and operation and maintenance personnel to make determinations and take effective measures to deal with abnormal situations.

The intelligent processing unit receives the video files sent by the intelligent binocular perception terminal, the intelligent perception terminal and the intelligent recognition terminal, processes the video files to generate the image data, and sends the image data to the intelligent service unit.

The intelligent binocular perception terminal, the intelligent perception terminal and the intelligent recognition terminal acquire video data and temperature monitoring data of a transmission chain system, a yaw system, a hydraulic system, a power generation system, a frequency converter, a main control system and surrounding areas.

The intelligent binocular perception terminal can not only recognize related equipment defects, smoke and open flames, and personnel violations, but can also monitor the equipment temperature in real time. If the equipment temperature abnormally heats up and exceeds the threshold, it will immediately alarm, and the operation and maintenance personnel can take immediate measures to reduce the risk of accidents.

The intelligent perception terminal presets a position at which the intelligent binocular perception terminal cannot acquire data, and then cyclically acquires videos of the preset position.

The intelligent recognition terminal specifically acquires videos of key parts for recognizing special defects and trespasses.

It should be noted that during operation of the novel visual recognition system for wind turbines, the intelligent binocular perception terminal, the intelligent perception terminal, and the intelligent recognition terminal with different functions are arranged in different positions in the wind turbines based on different models of wind turbines, to acquire video data and temperature monitoring data of the transmission chain system, the yaw system, the hydraulic system, the power generation system, the frequency converter, the main control system and surrounding areas. The intelligent perception terminal presets the position at which the intelligent binocular perception terminal cannot acquire data, and then cyclically acquires videos of the preset position. The intelligent recognition terminal acquires videos of key parts for recognizing special defects and trespasses. The intelligent binocular perception terminal, the intelligent perception terminal, and the intelligent recognition terminal are all connected to the video storage unit and the intelligent processing unit through the optical fibers and the router, and transmit the acquired video information to the video storage unit and the intelligent processing unit. The intelligent processing unit is connected to the intelligent service unit through the dedicated line, and the intelligent processing unit processes the video files to generate the image data and sends the image data to the intelligent service unit. The intelligent service unit is connected to the intelligent analysis unit, and the intelligent service unit transmits the image data processed by the intelligent processing unit to the intelligent analysis unit for analysis and determining. The intelligent analysis unit returns the alarm information and images generated after analysis and determining to the intelligent service unit. The intelligent service unit is connected to the telecontrol platform and the graphic workstation for data exchange and information display. In this way, equipment visual monitoring, temperature measurement, defect recognition, and full coverage of personnel behaviors are realized. The intelligent binocular perception terminal can monitor equipment defects, smoke and open flames, and personnel violations, and monitor an equipment operation temperature in real time. The intelligent binocular perception terminal alarms immediately when the equipment temperature exceeds the threshold, such that the operation and maintenance personnel can take immediate measures to reduce the risk of accidents. The intelligent analysis unit analyzes and processes the received image data, recognizes equipment defects, equipment abnormalities, and abnormal monitoring data, and then generates and sends the alarm information and alarm images to the intelligent service unit for subsequent processing. The intelligent service unit sends, based on different requirements and levels, the received information such as the alarm information, alarm images and abnormal data to the telecontrol platform and the graphic workstation, to facilitate the dispatchers and operation and maintenance personnel to make determinations and take effective measures to deal with abnormal situations. The present disclosure provides a reasonable structure to take a clear night shoot and ceaselessly monitor the wind turbine related equipment and maintenance personnel. In this way, real-time recognition of equipment defects and timely warning are achieved, operation and maintenance blind spots are reduced, the number of manual inspections is decreased, operation and maintenance efficiency is improved, operation and maintenance costs are reduced, and the safety risks of patrol personnel is reduced. The present disclosure can comprehensively improve the intelligent operation and maintenance level of wind turbines, prevent the accidents, and provide a strong guarantee for the safe and stable operation of the wind turbines.

The above-mentioned intelligent binocular perception terminal, the intelligent perception terminal, and the intelligent recognition terminal may be computing devices such as desktop computers, notebooks, palmtops, and cloud servers; and the terminals each may include, but not limited to, components such as a camera, a sensor, a processor, and a memory. The intelligent analysis unit, the intelligent service unit configured to transmit image data, the telecontrol platform, the graphic workstation, the intelligent processing unit configured to process video files, and the video storage unit configured to store video information may all be processors, intelligent terminals, tablets, PCs, cloud servers, or other devices.

Although the examples of the present disclosure have been illustrated and described, it should be understood that those of ordinary skill in the art may make various changes, modifications, replacements and variations to the above examples without departing from the principle and spirit of the present disclosure, and the scope of the present disclosure is limited by the appended claims and their legal equivalents.

1. A visual recognition system for wind turbines, comprising an intelligent analysis unit configured to analyze and determine data information, an intelligent service unit configured to transmit image data, a telecontrol platform, a graphic workstation, an intelligent processing unit configured to process video files, a router, a video storage unit configured to store video information, an intelligent binocular perception terminal, an intelligent perception terminal and an intelligent recognition terminal, wherein the intelligent binocular perception terminal, the intelligent perception terminal and the intelligent recognition terminal are connected to the video storage unit and the intelligent processing unit through optical fibers and the router, the intelligent processing unit is connected to the intelligent service unit through a dedicated line, the intelligent service unit is connected to the telecontrol platform and the graphic workstation for data exchange and information display, and the intelligent service unit is connected to the intelligent analysis unit.

2. The visual recognition system for wind turbines according to claim 1, wherein the intelligent analysis unit analyzes and processes the image data transmitted by the intelligent service unit, recognizes equipment defects, equipment abnormalities, and abnormal monitoring data, and then generates and sends alarm information and alarm images to the intelligent service unit for subsequent processing.

3. The visual recognition system for wind turbines according to claim 2, wherein the intelligent service unit receives the image data processed by the intelligent processing unit, and transmits the image data to the intelligent analysis unit for analysis and determining, and the intelligent service unit sends, based on different requirements and levels, the received information such as the alarm information, alarm images and abnormal data to the telecontrol platform and the graphic workstation, to facilitate dispatchers and operation and maintenance personnel to make determinations and take effective measures to deal with abnormal situations.

4. The visual recognition system for wind turbines according to claim 1, wherein the intelligent processing unit receives the video files sent by the intelligent binocular perception terminal, the intelligent perception terminal and the intelligent recognition terminal, processes the video files to generate the image data, and sends the image data to the intelligent service unit.

5. The visual recognition system for wind turbines according to claim 1, wherein the intelligent binocular perception terminal, the intelligent perception terminal and the intelligent recognition terminal acquire video data and temperature monitoring data of a transmission chain system, a yaw system, a hydraulic system, a power generation system, a frequency converter, a main control system and surrounding areas.

6. The visual recognition system for wind turbines according to claim 1, wherein the intelligent binocular perception terminal is configured to recognize related equipment defects, smoke and open flames, and personnel violations, and monitor an equipment temperature in real time; and
the intelligent binocular perception terminal is specifically configured to: immediately issue an alarm when monitoring that the equipment temperature exceeds a threshold, such that the operation and maintenance personnel can take immediate measures to reduce the risk of accidents.

7. The visual recognition system for wind turbines according to claim 1, wherein the intelligent perception terminal presets a position at which the intelligent binocular perception terminal cannot acquire data, and then cyclically acquires videos of the preset position.

8. The visual recognition system for wind turbines according to claim 1, wherein the intelligent recognition terminal specifically acquires videos of key parts for recognizing special defects and trespasses.
